(19) United States
(12) Patent Application Publication
(10) Pub. No.: US 2016/0300430 A1
(43) Pub. Date: Oct. 13, 2016

(54) SYSTEM AND METHOD FOR ON-LINE WAGERING ON REAL-TIME EVENTS

(71) Applicant: iPro, Inc., Incline Village, NV (US)

(72) Inventors: David ORTIZ, Newcastle, WA (US); Robert MELENDRES, Incline Village, NV (US); Shanmugapriyan DEVARAJ, Portland, OR (US)

(21) Appl. No.: 14/684,134

(22) Filed: Apr. 10, 2015

(51) Int. Cl. G07F 17/32

(52) U.S. Cl. CPC G07F 17/3211; G07F 17/3288; G07F 17/3225

(57) ABSTRACT

System and method for on-line wagering on real-time events. A computer-implemented method includes displaying, on a display coupled to the computer, at least a portion of a list including available wager categories. The available wager categories correspond to real-time events that are subject to wagers within a gaming system. First user input is accessed at the computer to select one of the available wager categories from the list of available wager categories. Responsive to a selected wager category, a plurality of images of available real-time events of the selected wager category is displayed on the display. The method also includes accessing, at the computer, second user input to select one of the real-time events from the list of available real-time events, responsive to a selected real-time event, displaying, on the display, a list of predetermined wagers corresponding to the selected real-time event and accessing, at the computer, third user input to select one of the predetermined wagers corresponding to the selected real-time event.

### RELATED APPLICATIONS

This application is related to co-pending, commonly owned U.S. patent application Ser. No. ______, attorney docket IPRO-0001-01.01US, filed Apr. 10, 2015, entitled “Method and System for Seamless Transitions between Game Types for Portable Computer Systems” to Devaraj et al., and is hereby incorporated by reference herein in its entirety.

This application is related to co-pending, commonly owned U.S. patent application Ser. No. ______, attorney docket IPRO-0002-01.01US, filed Apr. 10, 2015, entitled “System and Method for Accepting and Creating Electronic Wagers” to Ortiz et al., and is hereby incorporated by reference herein in its entirety.

This application is related to co-pending, commonly owned U.S. patent application Ser. No. ______, attorney docket IPRO-004-01.01US, filed Apr. 10, 2015, entitled “System and Method for On-line Fantasy Wagering” to Ortiz et al., and is hereby incorporated by reference herein in its entirety.

This application is related to co-pending, commonly owned U.S. patent application Ser. No. ______, attorney docket IPRO-005-01.01US, filed Apr. 10, 2015, entitled “System and Method for On-Line Multi-Player Interactive Wagering” to Devaraj et al., and is hereby incorporated by reference herein in its entirety.

This application is related to co-pending, commonly owned U.S. patent application Ser. No. ______, attorney docket IPRO-0006-01.01US, filed Apr. 10, 2015, entitled “Graphical User Interface for On-Line Gaming” to Ortiz et al., and is hereby incorporated by reference herein in its entirety.

U.S. Pat. No. 8,790,176, entitled “System and Method for Real Time Interactive Entertainment” to Hopf and Ortiz, is hereby incorporated by reference in its entirety.

### FIELD OF INVENTION

Embodiments of the present invention relate to the field of electronic applications for mobile computer systems. More specifically, embodiments of the present invention relate to systems and methods for on-line wagering on real-time events.

### BACKGROUND

On-line wagering is frequently restricted to sporting events. Many potential customers of an on-line gambling environment are not fans of sports, and/or wish to wager on a wider field of real-time events.

### SUMMARY OF THE INVENTION

Therefore, what is needed are systems and methods for on-line wagering on real-time events. What is additionally needed are systems and methods for on-line wagering on real-time events that enable a player to place a wager on a non-sporting real-time event. A need also exists for systems and methods for on-line wagering on real-time events that utilize effective and intuitive graphical user interfaces. Further, a need exists for systems and methods for on-line wagering on real-time events that are compatible and complementary with existing systems and methods of on-line and/or mobile gaming. Embodiments of the present invention provide these advantages.

In accordance with a first method embodiment of the present invention, a computer-implemented method includes displaying, on a display coupled to the computer, at least a portion of a list including available wager categories. The available wager categories correspond to real-time events that are subject to wagers within a gaming system. First user input is accessed at the computer to select one of the available wager categories from the list of available wager categories. Responsive to a selected wager category, a plurality of images of available real-time events of the selected wager category is displayed on the display. The method also includes accessing, at the computer, second user input to select one of the real-time events from the list of available real-time events, responsive to a selected real-time event, displaying, on the display, a list of predetermined wagers corresponding to the selected real-time event and accessing, at the computer, third user input to select one of the predetermined wagers corresponding to the selected real-time event.

In accordance with another embodiment of the present invention, an article of manufacture including a computer readable medium having instructions stored thereon that, responsive to execution by an electronic system, cause the electronic system to perform operations including displaying at least a portion of a list including available wager categories, wherein the available wager categories correspond to real-time events that are subject to wagers within a gaming system, accessing first user input to select one of the available wager categories from the list of available wager categories, responsive to a selected high-level category, displaying a plurality of images of available real-time events of the selected wager category, accessing second user input to select one of the real-time events from the list of available real-time events, responsive to a selected real-time event, displaying a list of predetermined wagers corresponding to the selected real-time event and accessing third user input to select one of the predetermined wagers corresponding to the selected real-time event.

In accordance with a further embodiment of the present invention, an electronic system includes one or more processors coupled to a bus, a memory coupled to the one or more processors, wherein the memory includes instructions for the one or more processors and a graphical user interface coupled to the bus. The graphical user interface is configured to display at least a portion of a list including available wager categories, wherein the available wager categories correspond to real-time events that are subject to wagers within a gaming system, access first user input to select one of the available wager categories from the list of available wager categories, responsive to a selected high-level category, display a plurality of images of available real-time events of the selected wager category, access second user input to select one of the real-time events from the list of available real-time events, responsive to a selected real-time event, display a list of predetermined wagers corresponding to the selected real-time event, and access third user input to select one of the predetermined wagers corresponding to the selected real-time event.

### BRIEF DESCRIPTION OF THE DRAWINGS

The accompanying drawings, which are incorporated in and form an integral part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2A illustrates an exemplary graphical user interface (GUI) for selecting a wager, in accordance with embodiments of the present invention.

FIG. 2B illustrates an exemplary graphical user interface (GUI) for selecting a wager, in accordance with embodiments of the present invention.

FIG. 3 illustrates an exemplary graphical user interface (GUI) of a large screen embodiment for accepting a wager, in accordance with embodiments of the present invention.

FIG. 4 illustrates an exemplary graphical user interface (GUI) for selecting a wager event, in accordance with embodiments of the present invention.

FIG. 5 illustrates an exemplary graphical user interface (GUI) for selecting a wager on a specific event, in accordance with embodiments of the present invention.

FIG. 6 illustrates an exemplary computer-implemented method, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### Notation And Nomenclature

Some portions of the detailed descriptions which follow (e.g., method 600) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accepting” or “selecting” or “determining” or “displaying” or “computing” or “sending” or “receiving” or “reducing” or “detecting” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The terms “micro event” and “sub-event” are used to refer to or to describe an activity within a larger “event,” the outcome of which may be subject to a wager. For example, a football game may be considered an “event,” while individual plays within the game may be considered “micro events.” Similarly, a baseball game may be considered an “event,” while each pitch, and the resulting outcome, e.g., ball, strike, single, double, triple, home run, sacrifice fly, etc., may be considered a “micro event.” For games with a less defined play structure, e.g., basketball, a fixed duration of game time, e.g., five minutes, may constitute a “micro event.” Embodiments in accordance with the present invention are well suited to wagers based on events and micro events within such events.

### System And Method for On-Line Wagering on Real-Time Events

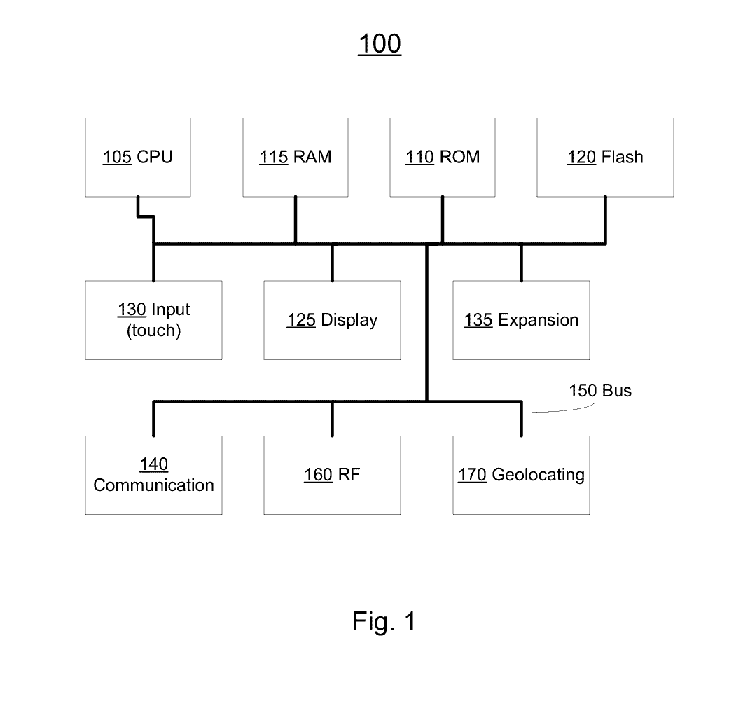

FIG. 1 illustrates an exemplary block diagram of an exemplary electronic system 100, which may be used as a platform to implement embodiments of the present invention. Electronic system 100 may be battery-powered, in some embodiments. Electronic system 100 may be a “server” computer system, in some embodiments. Electronic system 100 may comprise a desktop or generally “fixed location” computer system, in some embodiments. Electronic system 100 may comprise aportable computer system, e.g., a “smart” phone. Electronic system 100 may comprise a “wearable” computer system, e.g., a “smart” watch or an “eye-glasses-mounted” computer system. Electronic system 100 includes an address/data bus 150 for communicating information, a central processor 105 functionally coupled with the bus for processing information and instructions. Central processor 105 may comprise a single processor or multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner, and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

A touch sensitive digitizer panel 130 is generally associated with the display unit 125. For example, a function of the touch sensitive digitizer panel 130 generally associated with the display unit 125 is to localize a touch input, e.g., from a finger and/or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express(PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may comprise signals substantially compliant with the signals of bus 150.

A wide variety of well-known devices may be attached to electronic system 100 via the bus 150 and/or expansion interface 135. Examples of such devices include without limitation rotating magnetic memory devices, flash memory devices, digital cameras, wireless communication modules, digital audio players, and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394, and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Electronic system 100 may comprise one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. Electronic system 100 may also determine its position via a mobile telephone network, for example, identifying, measuring signal strength, and/or triangulation of cell towers. Electronic system 100 may also determine its position from known locations of wireless networks, e.g., WiFi hotspots, from an internet protocol (IP) address, or any other applicable location service(s). Geolocation determining features 170 may comprise dedicated hardware, or may utilize components with one or more other uses.

In accordance with embodiments of the present invention, systems and methods for on-line wagering on real-time events enable a user or “player” to make and/or accept an electronic wager via an electronic system, e.g., a “smart” phone. A player may post potential wagers, e.g., wagers proposed by the player, and/or select from among wagers posted by other players. A “player” may be a natural person, a wager host, e.g., an on-line casino, etc., a computer system, e.g., a “betting robot,” or other such entity. For example, a natural person may post a potential wager via embodiments in accordance with the present invention, seeking another player to accept such wager. An on-line casino may accept the wager. Similarly, an on-line casino may post a potential wager, and a natural person may, via embodiments in accordance with the present invention, accept the wager. Of course, two natural persons, e.g., some distance apart, using separate computers, may propose and accept, respectively, a wager, in accordance with embodiments of the present invention. All such combinations are to be considered within the scope of the present invention.

In accordance with embodiments of the present invention, an on-line wager may be created or accepted on myriad subjects, including, for example, sports, video games, reality and dating television shows, competition television shows, current events, celebrity news, stocks and/or businesses, news stories, elections, governance actions, e.g., Congressional votes, civil and/or criminal trial verdicts, military actions, space exploration, weather events and the like. The subjects included in wager categories may be determined from any suitable source of event information, including, for example, detecting subjects that are “trending” on social media, e.g., Twitter, Reddit, on search engines, e.g., Google, via news stories on press “wire” services, e.g., from the Associated Press (AP), Google News, BBC, a televised news “ticker” service, e.g., from Cable News Network (CNN) and the like. Wagers categories, and/or corresponding specific wagers, may be created automatically, e.g., via a computer-implemented process, or manually, in some embodiments. It is to be appreciated that an event or event category need not be televised, live or delayed, to be included in a list of wager categories.

Wagers categories, and/or corresponding specific wagers are subject to the laws of the jurisdiction occupied by the player. For example, a “proposition bet” may not be legal in some jurisdictions. Co-pending, commonly owned U.S. patent application Ser. No. 13/______, attorney docket IPRO-0001-01.01US, filed Apr. 10, 201?, entitled “Method and System for Seamless Transitions between Game Types for Portable Computer Systems” to Devaraj et al., included by reference herein in its entirety, discloses further information on determining legal jurisdiction for wagering.

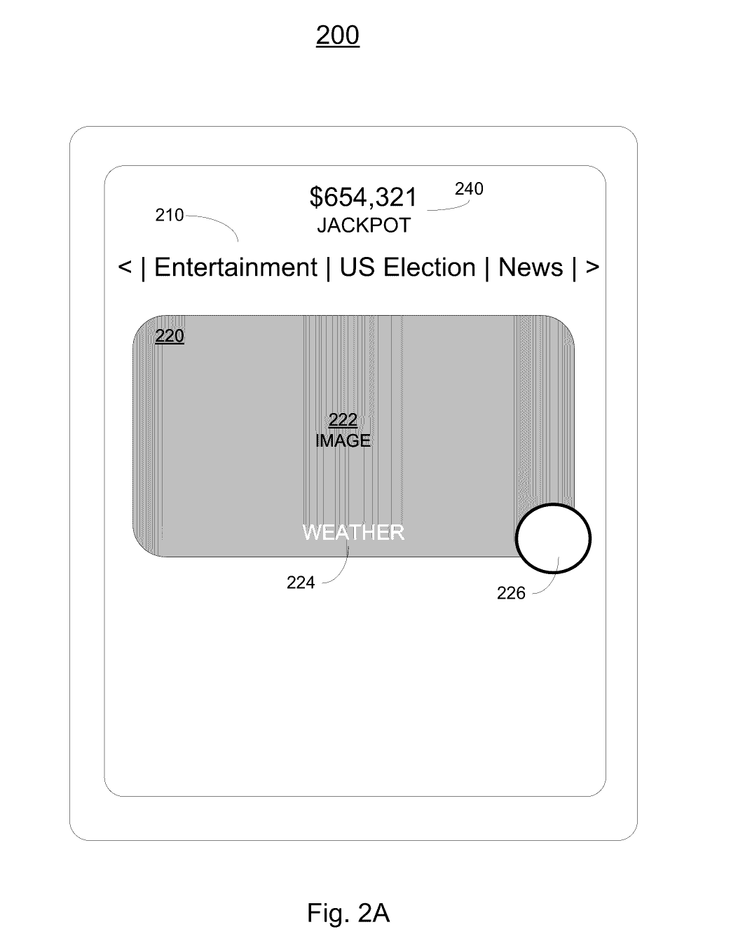

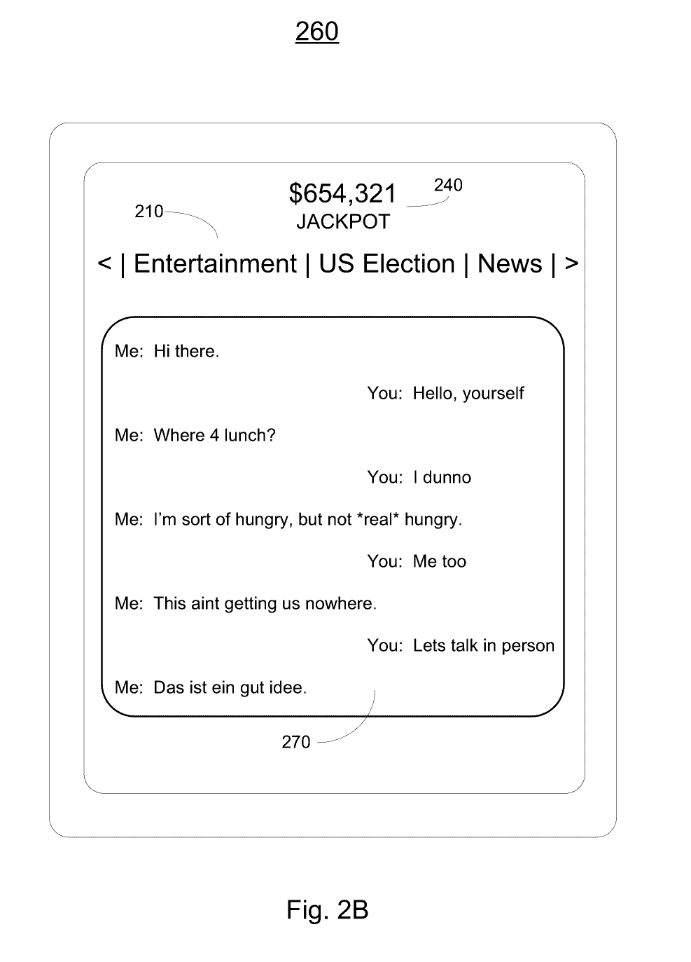

FIG. 2A illustrates an exemplary graphical user interface (GUI) 200 for selecting a wager, in accordance with embodiments of the present invention. Graphical user interface 200 may be displayed, for example, on display unit 125 of electronic system 100, as illustrated in FIG. 1. User input to the electronic system 100 may be accepted from a touch sensitive digitizer panel, e.g., touch sensitive digitizer panel 130 of FIG. 1, an attached keyboard, voice recognition, eye tracking, spatial gesture recognition, or any other suitable input device. Element 210 of graphical user interface 200 is an exemplary wager category selection mechanism. A user may scroll and/or page, e.g., via “swiping” actions, via a mouse or other pointing device, via cursor control keys, or the like, to select a wager category, e.g., a particular NFL team, for potential wagers. The display of element 210 may also scroll automatically, for example, as a “ticker,” or automatically page at regular intervals, in some embodiments.

Wager categories may include any category suitable for wagering in a user's jurisdiction. Exemplary high-level categories include sporting events, video games, award shows, “reality” shows, elections, trial verdicts, news stories, current events, elections, weather events, and most other “real-time” events. Embodiments in accordance with the present invention are well suited to horizontal scrolling, as illustrated, or vertical scrolling (not shown). According to a selection of a wager category indicated by wager category selection 210, only proposed wagers conforming to the wager category, e.g., wagers on or about “entertainment,” are displayed.

Element 220 of graphical user interface 200 is an exemplary alternate wager category selection mechanism, in accordance with embodiments of the present invention. Alternate wager category selection mechanism 220 comprises an image 222 corresponding to or suggestive of a wager category. For example, image 222 may comprise an image of a television contest show to illustrate such a category. Image 222 may be a still image or a video image, in accordance with embodiments of the present invention. Image 222 may also comprise a textual category title 224, e.g., “Weather.” Image 222 may further comprise a selection icon 226. Selection icon 226 may comprise a hollow ring with a gold colored border, in some embodiments. Selection of selection icon 226, e.g., by touching or otherwise indicating, indicates that a user is interested in wagering on events in a category corresponding to the image 222.

Graphical user interface 200 may also comprise a jackpot display 240, in accordance with embodiments of the present invention. Jackpot display 240 may indicate an amount available to participants and/or winners of wagers within a gaming system. For example, certain wagers and/or wager categories may be a part of a jackpot pool. A user winning and/or participating in a wager that is part of a jackpot pool may win all or a portion of the jackpot pool, for example, as a random drawing among such participants. Generally, inclusion in such a jackpot pool may be indicated by a different version of a selection icon 226, e.g., inclusion of a currency symbol, e.g., “$,” in a hollow circle.

In accordance with embodiments of the present invention, various portions of graphical user interface 200 may be incorporated into other displays. For example, exemplary wager category selection mechanism 210 may appear as a scrolling “ticker” over and/or with a display of an independent application.

FIG. 2B illustrates an exemplary graphical user interface (GUI) 260 for selecting a wager, in accordance with embodiments of the present invention. Graphical user interface 260 comprises display 270 of an independent, e.g., non-gambling, application, in this example a “chat” application. Elements of graphical user interface 200, e.g., wager category selection mechanism 210 and/or jackpot display 240 have been added to the display 270. In this novel manner, a user of other applications may be made aware of opportunities to wager on real-time events.

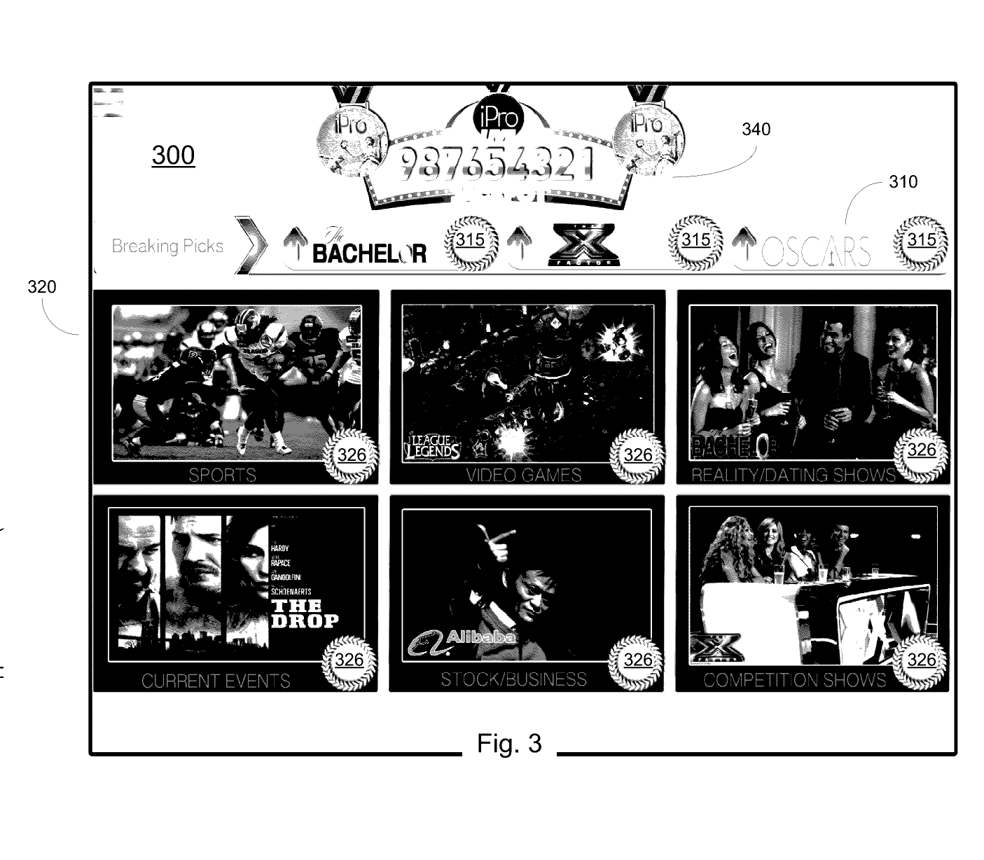

FIG. 3 illustrates an exemplary graphical user interface (GUI) 300 of a large screen embodiment for accepting a wager, in accordance with embodiments of the present invention. Graphical user interface 300 may be appropriate for a tablet computer, for example. Graphical user interface 300 comprises exemplary wager category selection mechanism 310. Similarly to exemplary wager category selection mechanism 210 of FIG. 2, exemplary wager category selection mechanism 310 presents, and allows selection of, a plurality of wager categories. Touching, or otherwise indicating selection icon 315 will display events within the particular category.

Graphical user interface 300 also comprises exemplary alternate wager category selection mechanism 320, in accordance with embodiments of the present invention. Alternate wager category selection mechanism 320 comprises a plurality of images corresponding to or suggestive of a wager category. The images may be still images and/or video images, including live video images. There may be a textual title associated with some images, in some embodiments. Associated with each image is a selection icon 326. Selection icon 326 may comprise a hollow ring with a gold colored border, in some embodiments. Selection of selection icon 326, e.g., by touching or otherwise indicating, indicates that a user is interested in wagering on events in a category corresponding to the image.

Graphical user interface 300 may also comprise a jackpot display 340, in accordance with embodiments of the present invention. Jackpot display 340 may indicate an amount available to participants and/or winners of wagers within a gaming system. For example, certain wagers and/or wager categories may be a part of a jackpot pool. Generally, inclusion in such a jackpot pool may be indicated by a different version of a selection icon 326, e.g., inclusion of a currency symbol, e.g., “$,” in a hollow circle.

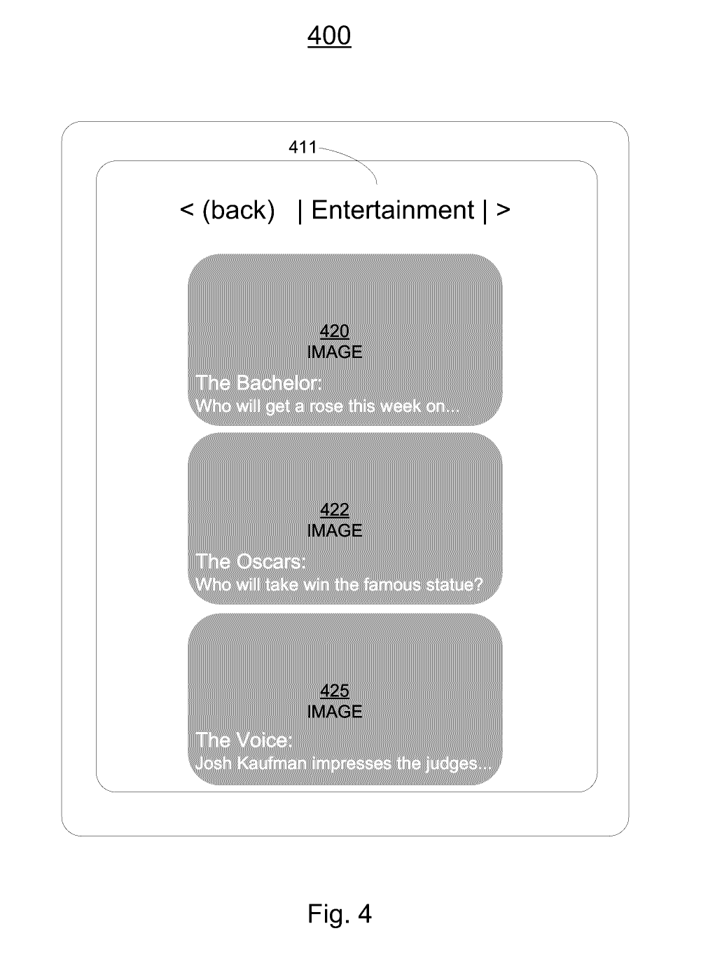

FIG. 4 illustrates an exemplary graphical user interface (GUI) 400 for selecting a wager event, in accordance with embodiments of the present invention. Graphical user interface 400 is presented responsive to touching or otherwise indicting a wager category, e.g., a category from element 210 of FIG. 2A, selecting selection icon 226 of FIG. 2A, selecting a wager category from wager category selection mechanism 310 of FIG. 3, or selecting a selection icon 326 of FIG. 3. Graphical user interface 400 comprises a display 410 of the subject wager, including the odds of the wager, if any.

Graphical user interface 400 comprises a display 411 of a selected wager category, for example, “entertainment,” corresponding to a category selection, as previously described. Graphical user interface 400 also comprises a plurality of images 420, 422, 425 corresponding to specific events in the selected category, for example, an image of “The Bachelor” television competition show 420, an image of “The Oscars” television awards show 422 and/or an image of “The Voice” television competition show 425. The images 420, 422, 425 may be still images and/or video images, including live video images, in some embodiments. Touching or otherwise indicating one of the plurality of images 420, 422, 425 will present a graphical user interface for wagering on the corresponding specific event.

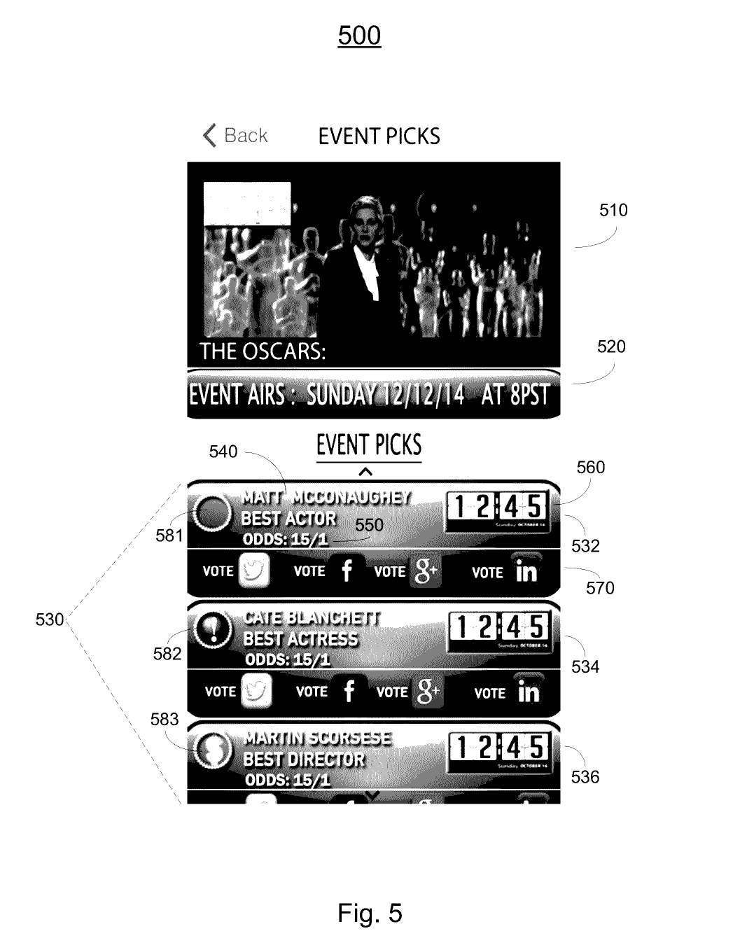

FIG. 5 illustrates an exemplary graphical user interface (GUI) 500 for selecting a wager on a specific event, in accordance with embodiments of the present invention. Responsive to a selection of a specific event, e.g., touching or otherwise indicating image 422 of FIG. 4, graphical user interface 500 is presented. Graphical user interface 500 comprises an image 510 of, or corresponding to, the selected event. For example, image 510 may comprise a still image from “The Oscars” television awards program. The image 510 may be a still image, for example, a picture or a logotype, and/or a video image, including live video images, in some embodiments. Graphical user interface 500 also comprises textual details of the event, for example, when the event occurs or will be televised.

Graphical user interface 500 further comprises a list 530 of wagers that are available for the selected event. List 530 may scroll and/or page e.g., via “swiping” actions, via a mouse or other pointing device, via cursor control keys, or the like, to display a greater number of wagers that are accommodated by a single display screen. List 530 comprises a plurality of individual wagers, each comprising a specific wager display, e.g., specific wager displays 532, 534 and 536 (partially shown).

Each specific wager display comprises a title 540, e.g., “Matt McConaughey (wins) Best Actor.” Each specific wager display also comprises an odds display 550, corresponding to the specific wager, e.g., the odds are 15 to one that Matt McConaughey will win the Oscar for Best Actor. Each specific wager display comprises a countdown timer 560. Countdown timer 560 indicates an amount of time remaining to accept the specific wager. Each specific wager display further comprises a countdown timer 560. Each specific wager display further comprises a list 570 of icons of electronic communication systems including, for example, social media, electronic mail, and/or short message service (“SMS”) communications. By touching or otherwise selecting one of the icons 570, a user is able to express an opinion or support for the specific wager in the indicated communication system. For example, touching the “Twitter” (bird) icon of the “Matt McConaughey” wager may send a “tweet” from the user indicating that the user thinks Matt McConaughey will win the Best Actor Oscar. The messages may be pre-formatted and/or user-editable, in some embodiments.

Each specific wager display also comprises a selection icon, e.g., selection icons 581, 582 and/or 583. Touching or otherwise selecting one of the selection icons 581, 582 and/or 583 indicates that a user wants to accept the corresponding specific wager. The selection icons 581, 582, 583 additionally may indicate a status of the wager. For example, the inclusion of an exclamation point “!” in selection icon 582 indicates that at least one other user has accepted the specific wager, in this example, a wager that Cate Blanchett will win a Best Actress Oscar. The inclusion of a currency symbol, e.g., “$,” in selection icon 583 indicates that the specific wager is part of a jackpot pool, for example, as described with respect to graphical user interface 200 of FIG. 2A.

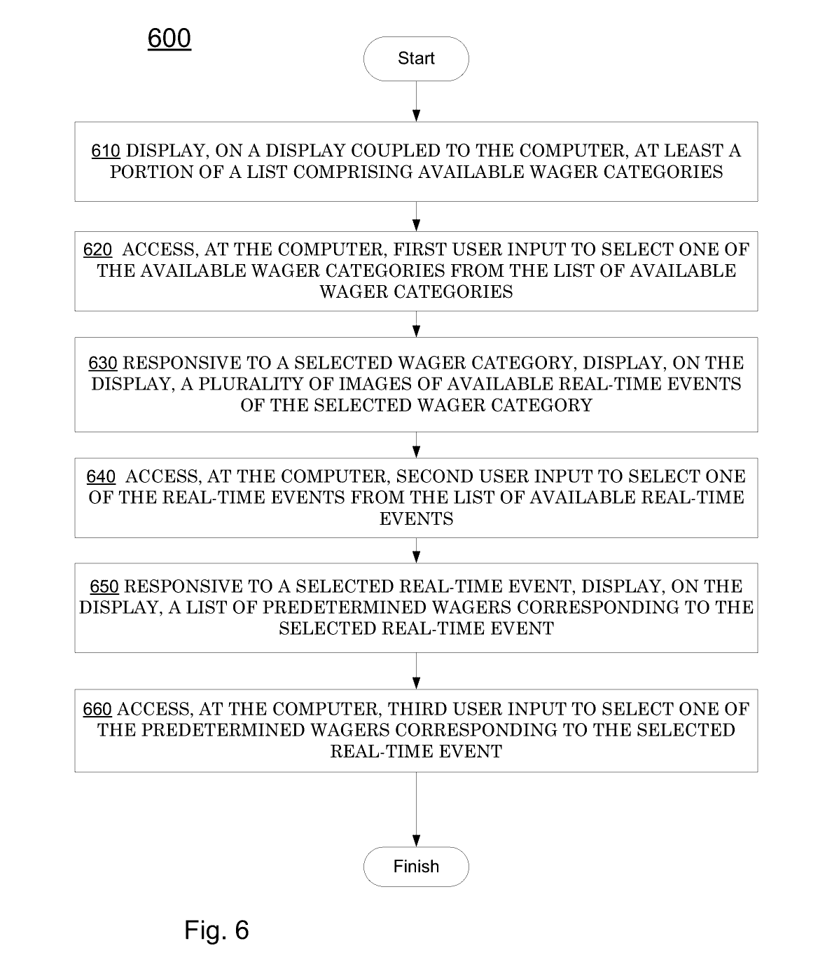

FIG. 6 illustrates an exemplary computer-implemented method 600, in accordance with embodiments of the present invention. In 610, at least a portion of a list comprising available wager categories is displayed on a display coupled to the computer, for example, display 125 of FIG. 1. The display may be a part of a computer system, e.g., an integral element as in a smart phone, or may be externally coupled to a computer, as is known, for example, with desktop computer systems. Element 210 of FIG. 2A illustrates an exemplary embodiment of such a list. The list may automatically scroll, without user intervention, to display the entire list, for example, if the list is larger than the available display area. Image 220 of FIG. 2A illustrates another exemplary embodiment of such a display. Image 220 may be a still image or a video image. The list, or portion thereof, may also be displayed in conjunction with a display of a non-gaming application. Element 210 of FIG. 2B illustrates an exemplary embodiment of such a display in conjunction with another application.

In 620, a first user input is accepted to select one of the available wager categories from the list of available wager categories. The input may be accessed though input device(s) 130 of FIG. 1, for example, and may include a user touching an item within the displayed list. In 630, responsive to a selected wager category, a plurality of images of available real-time events of the selected wager category is displayed on the display. Image 420 of FIG. 4 illustrates an exemplary embodiment of a display of available real-time events of the selected wager category. In 640, a second user input is accepted to select one of the real-time events from the list of available real-time events.

In 650, responsive to a selected real-time event, a list of predetermined wagers corresponding to the selected real-time event is displayed on the display. List 530 of FIG. 5 illustrates an exemplary embodiment of such a list. In accordance with some embodiments of the present invention, an image corresponding to one of the available wager categories may be displayed. The image may be a still image or a video image. A video image may be a real-time video image, in some embodiments. Image 510 of FIG. 5 illustrates an exemplary embodiment of such an image. In some embodiments of the present invention, a predetermined wager display may include a countdown timer, e.g., countdown timer 560 of FIG. 5, to indicate time remaining to accept the predetermined wager. In some embodiments of the present invention, a predetermined wager display may include a display of odds of the predetermined wager, e.g., odds display 550 of FIG. 5. In some embodiments of the present invention, a predetermined wager display may include a display of a list of icons, e.g., list 570 of FIG. 5, of icons of electronic communication systems operable to send a user comment concerning the predetermined wager to a selected electronic communication system. The icons may or may not reflect a service provider's trade dress. In some embodiments of the present invention, a predetermined wager display may include a selection icon, e.g., selection icons 581, 582, and/or 582 of FIG. 5. The selection icon may indicate a status of the wager. Wager statuses may include at least one other player has accepted a specific wager, e.g., selection icon 582 of FIG. 5, and a specific wager is part of a jackpot pool, e.g., selection icon 582 of FIG. 5.

In 660, a third user input is accessed to select one of the predetermined wagers corresponding to the selected real-time event. Co-pending, commonly owned U.S. patent application Ser. No. 13______, attorney docket IPRO-0002-01.01US, filed Apr. 10, 2015, entitled “System and Method for Accepting and Creating Electronic Wagers” to Ortiz et al., incorporated by reference herein in its entirety, discloses further details of actions responsive to selecting a specific wager.

Embodiments in accordance with the present invention provide systems and methods for on-line wagering on real-time events. In addition, embodiments in accordance with the present invention provide systems and methods for on-line wagering on real-time events that enable a player to place a wager on a non-sporting real-time event. Also, embodiments in accordance with the present invention provide systems and methods for on-line wagering on real-time events s that utilize effective and intuitive graphical user interfaces. Further, embodiments in accordance with the present invention provide systems and methods for on-line wagering on real-time events that are compatible and complementary with existing systems and methods of on-line and/or mobile gaming.

Various embodiments of the invention are thus described. While the present invention has been described in particular embodiments, it should be appreciated that the invention should not be construed as limited by such embodiments, but rather construed according to the below claims.

What is claimed is:

1. A computer-implemented method comprising:
displaying, on a display coupled to said computer, at least a portion of a list comprising available wager categories, wherein said available wager categories correspond to real-time events that are subject to wagers within a gaming system;
accessing, at said computer, first user input to select one of said available wager categories from said list of available wager categories;
responsive to a selected wager category, displaying, on said display, a plurality of images of available real-time events of said selected wager category;
accessing, at said computer, second user input to select one of said real-time events from said list of available real-time events;
responsive to a selected real-time event, displaying, on said display, a list of predetermined wagers corresponding to said selected real-time event; and
accessing, at said computer, third user input to select one of said predetermined wagers corresponding to said selected real-time event.

2. The computer-implemented method of claim 1 wherein said at least a portion of said list comprising available wager categories automatically scrolls, without user intervention, to display said list in its entirety.

3. The computer-implemented method of claim 1 wherein said at least a portion of a list comprising available wager categories is presented in conjunction with a display of a non-gaming application.

4. The computer-implemented method of claim 1 further comprising:
displaying an image corresponding to one of said available wager categories.

5. The computer-implemented method of claim 4 wherein said first user input comprises touching within said image.

6. The computer-implemented method of claim 1 further comprising:
responsive to a selected real-time event, displaying, on said display, a video image of said selected real-time event.

7. The computer-implemented method of claim 1 further comprising:
displaying, on said display, an amount of a jackpot pool.

8. The computer-implemented method of claim 1 wherein said displaying said list of predetermined wagers further comprises displaying a selection icon with each of said predetermined wagers, wherein said selection icon indicates a status of said each of said predetermined wagers, and wherein said status includes at least one other player has accepted a specific wager, and a specific wager is part of a jackpot pool.

9. An article of manufacture including a computer readable medium having instructions stored thereon that, responsive to execution by an electronic system, cause said electronic system to perform operations comprising:
displaying at least a portion of a list comprising available wager categories, wherein said available wager categories correspond to real-time events that are subject to wagers within a gaming system;
accessing first user input to select one of said available wager categories from said list of available wager categories;
responsive to a selected high-level category, displaying a plurality of images of available real-time events of said selected wager category;
accessing second user input to select one of said real-time events from said list of available real-time events;
responsive to a selected real-time event, displaying a list of predetermined wagers corresponding to said selected real-time event; and
accessing third user input to select one of said predetermined wagers corresponding to said selected real-time event.

10. The article of manufacture of claim 9 wherein said at least a portion of said list comprising available wager categories automatically scrolls, without user intervention, to display said list in its entirety.

11. The article of manufacture of claim 9 wherein said at least a portion of a list comprising available wager categories is presented in conjunction with a display of a non-gaming application.

12. The article of manufacture of claim 9 wherein said operations further comprise:
displaying an image corresponding to one of said available wager categories.

13. The article of manufacture of claim 9 wherein said operations further comprise:
responsive to a selected real-time event, displaying a video image of said selected real-time event.

14. The article of manufacture of claim 9 wherein said operations further comprise:
displaying an amount of a jackpot pool.

15. The article of manufacture of claim 9 wherein said operations further comprise:
displaying a selection icon with each of said predetermined wagers, wherein said selection icon indicates a status of said each of said predetermined wagers, and wherein said status includes at least one other player has accepted a specific wager, and a specific wager is part of a jackpot pool.

16. An electronic system comprising:
one or more processors coupled to a bus;
a memory coupled to said one or more processors, wherein said memory comprises instructions for said one or more processors;
a position determining system coupled to said bus operable to determine a geolocation of said electronic system;
a graphical user interface coupled to said bus, wherein said graphical user interface is configured to:
display at least a portion of a list comprising available wager categories, wherein said available wager categories correspond to real-time events that are subject to wagers within a gaming system;
access first user input to select one of said available wager categories from said list of available wager categories;
responsive to a selected high-level category, display a plurality of images of available real-time events of said selected wager category;
access second user input to select one of said real-time events from said list of available real-time events;
responsive to a selected real-time event, display a list of predetermined wagers corresponding to said selected real-time event; and
access third user input to select one of said predetermined wagers corresponding to said selected real-time event.

17. The electronic system of claim 16 wherein said graphical user interface is further configured to:
display a countdown timer as part of each of said predetermined wagers indicating time remaining to accept each of said predetermined wagers.

18. The electronic system of claim 16 wherein said graphical user interface is further configured to:
display an odds of each of said predetermined wagers.

19. The electronic system of claim 16 wherein said graphical user interface is further configured to:
display a list of icons of electronic communication systems operable to send a user comment concerning a selected predetermined wager to a selected electronic communication system.

20. The electronic system of claim 16 wherein said graphical user interface is further configured to:
automatically scroll said at least a portion of a list comprising available wager categories to display said list in its entirety over time.

21. A computer-implemented method comprising:
displaying, on a display coupled to said computer, a list comprising real-time events that are subject to wagers within a gaming system;
accessing, at said computer, first user input to select one of said real-time events;
responsive to a selected real-time event, displaying, on said display, a list of predetermined wagers corresponding to said selected real-time event; and
accessing, at said computer, third user input to select one of said predetermined wagers corresponding to said selected real-time event.

22. The computer-implemented method of claim 21 wherein said at least a portion of said list of real-time events automatically scrolls, without user intervention, to display said list in its entirety.

23. The computer-implemented method of claim 21 further comprising:
displaying, on said display, a plurality of images of said available real-time events.

24. The computer-implemented method of claim 23 wherein said first user input comprises touching within one of said plurality of images.

25. The computer-implemented method of claim 23 responsive to a selected real-time event, displaying, on said display, a video image of said selected real-time event.

26. The computer-implemented method of claim 21 wherein said at least a portion of said list of real-time events is presented in conjunction with a display of a non-gaming application.
